(19) United States
(12) Patent Application Publication
(10) Pub. No.: US 2018/0202548 A1
(43) Pub. Date: Jul. 19, 2018

(54) VEHICLE DRIVE TRAIN AND METHOD FOR OPERATING A DRIVE TRAIN

(71) Applicant: ZF Friedrichshafen AG, Friedrichshafen (DE)

(72) Inventors: Wolfgang REBHOLZ, Sauldorf-Krumbach (DE); Jürgen LEGNER, Friedrichshafen (DE)

(21) Appl. No.: 15/864,430

(22) Filed: Jan. 8, 2018

(30) Foreign Application Priority Data
Jan. 16, 2017 (DE) 10 2017 200 561.0

(51) Int. Cl. F16H 61/4017; B60K 17/34; B60K 17/10; F16H 39/04

(52) U.S. Cl. CPC F16H 61/4017; B60K 17/34; F16H 2059/506; F16H 39/04; B60K 17/10

(57) ABSTRACT

A vehicle drive-train with a drive engine, a drive output and a transmission device connected in the power flow between the drive engine and the drive output. The transmission device has at least two transmission units whose transmission ratios can be varied continuously, at least in some ranges, and which are arranged in power-trains running parallel with one another between the drive engine and the drive output. The power-trains can each be functionally connected with a respective axle of the drive output. At least one shifting element is provided by which the power-trains can be functionally connected in the area between the transmission units and the drivable axles. In addition, a method for operating the vehicle drive-train is described, in which the shifting element is actuated as a function of torque to be transmitted via the transmission device between the drive engine and the drive output.

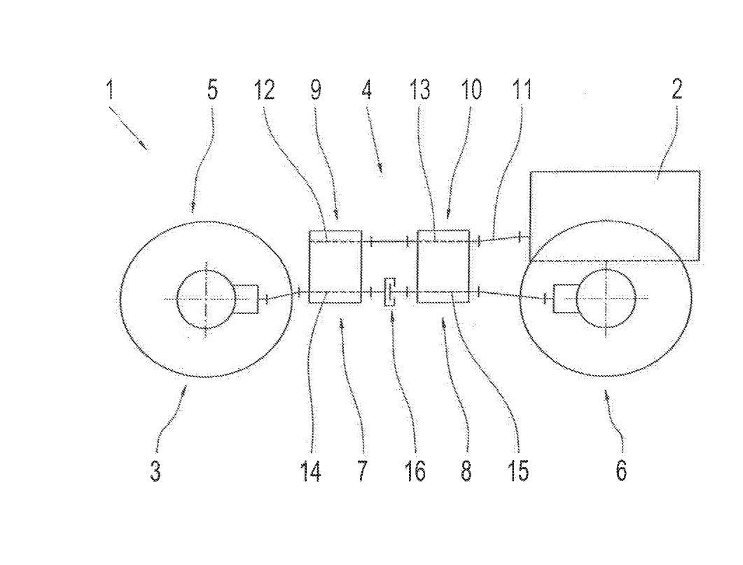

This application claims priority from German patent application serial no. 10 2017 200 561.0 filed Jan. 16, 2017.

### FIELD OF THE INVENTION

The invention concerns a vehicle drive-train and a method for operating a vehicle drive-train.

### BACKGROUND OF THE INVENTION

From DE 10 2013 019 173 A1 a drive-train with a drive motor is known, which comprises at least two parallel drive outputs that start at the drive motor, and also at least two transmissions. Each transmission is connected to a respective parallel drive output. The drive outputs of the at least two transmissions are connected with at least one summing gear system. To compensate for transmission ratio differences between the transmissions, the drive-train comprises at least one differential gear system.

A disadvantage of this, however, is that over the full operating range of the drive-train the torque to be transmitted between the drive motor and the drive output of the drive-train passes by way of both transmissions. However, because of this an overall efficiency of the vehicle drive-train is compromised within defined operating ranges in which the respective torque to be transmitted can only pass by way of one of the transmissions without that one transmission being loaded to an unacceptable extent.

### SUMMARY OF THE INVENTION

Accordingly, the purpose of the present invention is to provide a vehicle drive-train characterized by a simply designed structure, and to enable an efficiency-optimized operation of a vehicle drive-train.

According to the invention, this objective is achieved by a vehicle drive-train and by a method for operating a vehicle drive-train, having the characteristics specified in the claims.

The vehicle drive-train according to the invention is made with a drive engine, a drive output, and a transmission device connected into the power flow between the drive engine and the drive output. The transmission device comprises at least two transmission units, whose transmission ratio can be varied continuously at least in some ranges and which are arranged in power-trains running parallel to one another between the drive engine and the drive output. In each case the power-trains can be brought into, or are, in functional connection with a drivable vehicle axle of the drive output.

According to the invention at least one shifting element is provided, by means of which the two power-trains can be brought into functional connection with one another in the area between the two transmission units and the drivable vehicle axles.

By virtue of the shifting element arranged according to the invention, in a simply designed manner it is now made possible, depending on the operating condition of the shifting element, to conduct the power to be passed through the transmission device via the transmission units engaged in parallel with one another and thereby to divide it between the number of transmission units provided in an appropriate manner and hence, with little effort, to limit the load in the area of the individual transmission units.

In addition, in the open operating condition of the shifting element it is possible, via one of the transmission units, to drive a drivable vehicle axle which for example is the front axle, while via the second transmission unit the drivable vehicle axle, which is for example the rear vehicle axle, is acted upon by a torque, without thereby producing internal stresses in the vehicle drive-train as is the case with connections between the front and rear axles which are solid to the usual extent. Thus, in a simple manner tire wear can be reduced, as also can be the energy consumption of the drive engine.

Furthermore, until the maximum power that can be transmitted by one of the transmission units is reached, it is possible to interrupt the power-train with the other transmission unit in it and thus to transmit torque between the drive engine and the drive output only by way of one of the transmission units while the other transmission unit is in a load-free condition.

If the shifting element is an interlocking shifting element, then in the open condition of the shifting element only small drag torques occur to compromise the overall efficiency of the vehicle drive-train.

In an advantageous embodiment of the vehicle drive-train according to the invention, the shifting element is in the form of a frictional shifting element whose transmission capacity can be varied continuously. In that case, in the open operating condition of the shifting element any rotational speed differences between the halves of the shifting element can be equalized by the shifting element itself in a simple manner. In addition, if appropriately designed, the shifting element can be changed to its closed operating condition when necessary, with little control and regulation effort.

In a further advantageous embodiment the efficiency of the vehicle drive-train according to the invention can be improved in a simple manner within certain operating ranges if, at least in the area of one of the power-trains, the force flow between the drive engine and the drive output can be interrupted by means of at least one shifting element. Power losses in the area of the transmission unit arranged in the disconnected power-train can then be reduced in a simple way.

If in the area of the transmission units the transmission ratios can be adjusted individually, then in a simple manner a slipping adjustment can be realized, which offers advantages particularly in the case of agricultural tractors.

If an output shaft of the drive engine is or can be brought into functional connection with transmission input shafts of the transmission units, and if transmission output shafts of the transmission units are respectively coupled to at least one drivable vehicle axle and by way of the shifting element can be connected to a respective transmission output shaft of the other transmission unit, then when the shifting element is open a particular drivable vehicle axle can be driven by the transmission unit associated with the vehicle axle, whereas in the closed operating condition of the shifting element both vehicle axles are acted upon by torque via both transmission units.

By virtue of the last-mentioned design configuration of the drive-train according to the invention, until the maximum power that can be transmitted by one of the transmission units has been reached the other transmission unit can be disconnected from the force flow of the vehicle drive-train in a simple manner and power losses occurring in the area of that transmission unit can be reduced or lowered to a minimum with little effort.

During operating condition variations in which the respective traction force provision to be made available in the area of the drive output is increasing, in a simple manner the second transmission unit can be connected into the force flow and it then also transmits torque or power between the drive engine and the drive output, in such manner that the power transmitted via the further transmission unit can be adjusted in a variable ratio to the power of the first transmission.

In such an operating condition the two power-trains are engaged together without a differential known from the prior art, and are functionally connected with one another on the output side only via the wheels and the ground.

If now inequalities in the operating behavior between the two transmission units occur, for example during a range change in the area of one of the two transmission units, then excessive torque increases or torque peaks are damped by the elasticity of the tires or compensated for, to some extent, by a corresponding slip in the area of the tires. Consequently, a vehicle drive-train according to the invention, configured as described, reacts with greater elasticity, or substantially more softly that a configuration of a vehicle drive-train having an essentially more solid coupling of the two transmission units by means of gearwheels and shafts. The correspondingly soft coupling of the transmission units according to the invention enables the vehicle drive-train to be produced without a differential gear system known from the prior art.

In the method according to the invention for operating a vehicle drive-train made as described above, the shifting element is actuated as a function of torque to be transmitted by the transmission device between the drive engine and the drive output.

Thus, depending on the operating condition the vehicle drive-train according to the invention can be operated with high efficiency without unacceptably overloading the transmission units.

If a predefined threshold value of the torque transmitted via the transmission device between the drive engine and the drive output is exceeded, and if the shifting element is changed to its dosed operating condition, then the vehicle drive-train can be operated in an efficiency-optimized manner and in addition unacceptably high loading of the transmission units can be avoided, with little control and regulation effort.

In an advantageous variant of the method according to the invention, the force flow between the drive engine and the drive output is interrupted in the area of one of the power-trains when the torque currently to be transmitted by the transmission device between the drive engine and the drive output is lower than another threshold value. In this way, again with little control and regulation effort it can be ensured, on the one hand, that the transmission units are not loaded to an unacceptable extent and, on the other hand, that the vehicle drive-train according to the invention can be operated with high efficiency, at least within defined operating ranges.

In a further advantageous variant of the method according to the invention, slippage in the area of the wheels of drivable vehicle axles can be adjusted in a controlled manner by varying the transmission ratio in the area of the transmission units with the shifting element operating open or in a slipping condition.

In an easily implemented variant of the method according to the invention, in the area of one of the transmission units, which is designed as a continuously variable power-branched transmission with a variator in the form of a hydrostat, by means of an adjustment strategy that takes account of a current driver's wish, a transmission ratio and high-pressure regulation is carried out. In this procedure, in a simple manner the nominal value specification for the transmission ratio and high-pressure regulation can be defined in accordance with the driver's wish or as a function of a predetermined limitation concerning the transmission ratio and the high pressure.

If in the area of the further transmission unit, which is also designed as a continuously variable power-branched transmission with a variator in the form of a hydrostat, by virtue of an adjustment strategy that takes into account a current driver's wish, transmission ratio regulation is carried out whereas the high-pressure regulation in the area of the variator of the further transmission unit is operated as a function of the high-pressure regulation in the area of the other transmission unit, the nominal value of the high-pressure regulation of the further transmission unit is not specified externally but determined from the measured value of the other transmission unit, whereby with little effort a 50:50 power division between the two power-trains of the vehicle drive-train can be achieved.

Both the characteristics specified in the claims and those indicated in the following example embodiment of the object of the invention are in each case suitable, whether taken in isolation or in any desired combination with one another, as further developments of the object of the invention.

Further advantages and advantageous embodiments of the principle of the object of the invention emerge from the claims and from the description given below with reference to the drawing.

### BRIEF DESCRIPTION OF THE DRAWING

The sole FIGURE shows a very schematic representation of a vehicle drive-train with a drive engine, a drive output and with a transmission device provided in the power flow between the drive engine and the drive output.

### DETAILED DESCRIPTION OF THE PREFERRED EMBODIMENTS

The FIGURE shows a vehicle drive-train 1 with a drive engine 2, a drive output 3 and a transmission device 4 connected between the drive engine 2 and the drive output 3. In the present case the drive engine is in the form of an internal combustion engine, preferably a diesel engine. Furthermore it is also possible for the drive engine 2 to comprise a combination of an internal combustion engine and an electric machine, or even a plurality of internal combustion engines and/or electric machines, in order to be able to produce a required traction force in the area of the drive output 3. In addition it is also possible for the drive engine 2 to consist of one or more electric machines.

In turn, the drive output 3 comprises two drivable vehicle axles 5, 6, such that in this case the vehicle axle 5 is the front axle of the vehicle and the axle 6 is the rear axle of the vehicle made with the drive-train 1, which vehicle can for example be a working machine such as a wheel loader or the like.

In the present case the transmission device 4 is made with two transmission units 7, 8, which are essentially structurally the same, each being a continuously variable power branched transmission with a variator in the form of a hydrostat. The transmission ratios of the transmission units 7, 8 can be varied continuously, at least in some ranges. In addition, the two transmission units 7, 8 are arranged in power-trains 9, 10 that run parallel with one another between the drive engine 2 and the drive output 3. The power-train 9 is in functional connection with the vehicle axle 5, whereas the power-train 10 is coupled to the vehicle axle 6.

An output shaft 11 of the drive engine 2 is functionally connected to transmission input shafts 12, 13. In the area of the transmission output shafts 14, 15, the transmission units 7, 8 are coupled to the drivable vehicle axles 5 and 6 respectively. In addition, the transmission output shafts 14, 15 of the transmission units 7, 8 can be brought into functional connection with one another by means of a shifting element 16 arranged between the transmission output shafts 14, 15, which shifting element 16 is in the present case in the form of a friction clutch and can also be operated with slip, should there be a corresponding need. The shifting element 16 can be controlled electronically and is therefore designed to be shifted fully automatically. Moreover, due to the arrangement of the shifting element 16, when the shifting element 16 is in its closed operating condition in each case only half of the total drive output torque is transmitted, namely the torque passing by way of one of the respective transmission units 7, 8.

Thus, the arrangement of the shifting element 16 described above makes it possible to design the shifting element 16 in a space-saving manner. This space-saving design of the shifting element 16 also has the advantage that in the open operating condition of the shifting element 16 only small drag torque losses are produced, since in the area of the shifting element 16 only small rotational speed differences occur throughout the operating range of the vehicle drive-train 1.

The above-described configuration of the vehicle drive-train 1 makes it possible in an inexpensive way to equip vehicles having powerful drive engines with standard transmissions which have a comparatively lower power, whereby the manufacturing costs of powerful vehicles can be limited to a desired extent.

Furthermore, the above-described configuration of the vehicle drive-train 1 when the shifting element 16 is open makes it possible to divide the torque to be passed via the transmission device 4 and the power to be transmitted, by virtue of the parallel connection, between the two transmission units 7 and 8. Then, the power transmitted via the transmission unit 7 can be made available in the area of the vehicle axle 5, whereas the power transmitted via the transmission unit 8 is provided in the area of the vehicle axle 6. During such an operating condition of the vehicle drive-train 1, in a simple manner internal stresses that occur with a conventional, solid connection between the vehicle axles 5 and 6 are avoided. This has fuel consumption advantages and reduces tire wear in the area of the vehicle axles 5 and 6.

In addition, by virtue of the individual regulation of the transmission ratio in the area of the transmission units 7 and 8, the slip in the area of the vehicle axles 5 and 6 can be regulated, which for example is very advantageous for agricultural tractors.

Until the maximum transmissible power or the maximum drive torque that can be transmitted by the transmission unit 7 or the transmission unit 8 is reached, it is also possible to disconnect the transmission unit 7 or the transmission unit 8 for example by opening a range clutch of the transmission unit 7 or of the transmission unit 8. This is advantageous, since in the decoupled operating condition of the transmission unit 7 or the transmission unit 8 no power loss occurs in the area of the hydrostatic variator.

In this context range clutches are shifting elements by means of which fixed gearwheel pairs in the area of the transmission units 7 and 8 can be connected or disconnected and by means of which fixed transmission ratios can be obtained. By virtue of the combination of the respective hydrostats provided and the fixed transmission ratios that can be engaged in each case, defined transmission ratio ranges of the transmission units can be obtained, within which the overall transmission ratio of the transmission units 7 and 8 can be varied continuously by adjusting the hydrostats.

Furthermore, it is also possible to disconnect the transmission unit 7 or the transmission unit 8 by correspondingly decoupling them from the drive engine 2, this being done for example by opening so-termed driving direction clutches by means of which the rotational direction in the area of the drive output 3 can be changed for forward driving or driving in reverse.

During operating condition variations in which, in the area of the drive output 3, more power or a higher drive torque has to be provided than can be passed through the transmission unit 7 or the transmission unit 8 alone, the previously disconnected transmission unit 7 or 8 is reconnected again and correspondingly transmits power or an appropriate drive torque onward in the direction toward the vehicle axle 5 or 6. The power transmitted by the additionally connected transmission unit 7 or 8 can be adjusted in a variable ratio to the drive output torque transmitted by the previously already connected transmission unit 7 or transmission unit 8.

If the drive torque provided by the drive engine 2 is transmitted simultaneously toward the drive output 3 by both of the transmission units 7 and 8, then the transmission ratio set in the area of the transmission units 7 and 8 and also their initial rotational speeds have to be set almost equal to one another. In this operating condition of the vehicle drive-train 1, in which the shifting element 16 is fully open or at least operated with slip, the vehicle axles 5 and 6 of the drive output 3 are interconnected by way of the wheels of the vehicle axles 5 and 6 and the ground being driven over. If inequalities occur, for example during a range change in the area of one of the transmission units 7 or 8, then torque peaks are damped by virtue of the elasticity of the tires of the vehicle axles 6 and 5 or compensated for to some extent by a corresponding tire slip.

For example, if a wheel loader is made with the vehicle drive-train 1, it is now possible that during a filling process of a scoop of the wheel loader the total drive torque provided by the drive engine has to be applied as a drive torque in the area of the front axle 5. During such an operating condition of the vehicle drive-train 1, the fixed mechanical connection between the front axle 5 and the rear axle 6 is still in place. For this, however, the shifting element 16 which can be in the form of a claw-type shifting element or a powershift clutch, is closed or at least its transmission capacity is increased to an extent such that the torque provided by the drive engine 2 is delivered in large measure to the front axle 5. The fixed connection between the transmission units 7 and 8 that can be produced by means of the shifting element 16 is in each case formed only for as long as necessary.

To avoid internal stress conditions in the area of the vehicle drive-train 1, it is provided that when the shifting element 16 is fully closed, the transmission unit 7, which in the present case is a so-termed master transmission, is operated using an adjustment strategy known in itself, by virtue of which a transmission ratio and high-pressure regulation is carried out with reference to a nominal value determined in accordance with a driver's wish or a predetermined limitation related to the transmission ratio and high pressure. The transmission unit 8, which is called the slave transmission in what follows, is operated with an adjustment strategy different from this, wherein the specification of the transmission ratio takes place as in the master transmission 7. The high-pressure regulation of the slave transmission 8, however, is operated with a nominal value specification determined on the basis of the high pressure in the master transmission 7. This means that the nominal value for the high-pressure regulation of the slave transmission 8 is not specified externally, but is determined with reference to the measured value determined in the area of the master transmission 7. In that way a 50:50 power division between the two transmission units 7 and 8 can be produced.

For example, if a slightly lower transmission ratio is set in the area of the master transmission 7 than in the area of the slave transmission 8, then in the area of the master transmission 7 a higher output rotational speed will be produced than in the area of the slave transmission 8. During such an operating condition of the vehicle drive-train 1, the slave transmission 8 brakes and increases the load in the area of the master transmission 7. However, since the high-pressure regulation in the area of the slave transmission 8 takes place at the same high pressure as in the area of the master transmission 8, the transmission ratio of the slave transmission 8 is reduced until in the area of the slave transmission 8 the same high pressure is set as in the area of the master transmission 7.

If a slightly higher transmission ratio is set in the area of the master transmission 7 than in the area of the slave transmission 8, the master transmission 7 brakes and increases the load in the area of the slave transmission 8. Due to the high-pressure regulation provided in the area of the slave transmission 8, which causes the high pressure in the area of the slave transmission 8 to change to the value of the high pressure in the area of the master transmission 7, the transmission ratio of the slave transmission 8 increases until in the area of the slave transmission 8 a high pressure is produced which corresponds to the high pressure in the area of the master transmission 7.

Depending on the application case at the time it is up to the discretion of a person with knowledge of the field to provide between the drive engine and the drive output of the vehicle drive-train more than two power-trains running parallel with one another, such that each power-train is made with at least one transmission unit. Furthermore, it is also possible in the area of the power-trains to provide in turn a parallel power branch with so-termed sub-power-trains, such that again each such train must be made with a transmission unit.

### INDEXES

1 Vehicle drive-train
2 Drive engine
3 Drive output
4 Transmission device
5 Vehicle axle, front axle
6 Vehicle axle, rear axle
7 Transmission unit
8 Transmission unit
9 Power-train
10 Power-train
11 Output shaft
12 Transmission input shaft
13 Transmission input shaft
14 Transmission output shaft
15 Transmission output shaft
16 Shifting element

1-12. (canceled)

13. A vehicle drive-train (1) comprising.
a drive engine (2),
a drive output (3),
a transmission device (4) being connected in a power flow between the drive engine (2) and the drive output (3),
the transmission device (4) comprising at least two transmission units (7, 8) whose transmission ratios are continuously variable, at least in some ranges, and which are arranged in power-trains (9, 10) running parallel with one another between the drive engine (2) and the drive output (3),
the power-trains (9, 10) each being functionally connectable with a respective vehicle axle (5, 6) of the drive output (3), and
at least one shifting element (16) being provided by which the power-trains (9, 10) can be functionally connected with one another in an area between the two transmission units (7, 8) and the drivable vehicle axles (5, 6).

14. The vehicle drive-train according to claim 13, wherein the shifting element (16) is an interlocking shifting element.

15. The vehicle drive-train according to claim 13, wherein the shifting element (16) is a frictional shifting element which has a transmission capacity that is continuously variable.

16. The vehicle drive-train according to claim 13, wherein a force flow between the drive engine (2) and the drive output (3), at least in an area of one of the power-trains (9, 10), is interruptable by at least one shifting element.

17. The vehicle drive-train according to claim 13, wherein the transmission ratio in an area of the transmission units (7, 8) is individually adjustable.

18. The vehicle drive-train according to claim 13, wherein an output shaft (11) of the drive engine (2) is functionally connectable with transmission input shafts (12, 13) of the transmission units (7, 8), and transmission output shafts (14, 15) of the transmission units (7, 8) are, in each case, coupled with at least one of the drivable vehicle axles (5, 6) and connectable by the shifting element (16) to a respective transmission output shaft (14 or 15) of the other transmission unit (7 or 8).

19. A method of operating a vehicle drive-train (1) having a drive engine (2), a drive output (3) and a transmission device (4) connected in the power flow between the drive engine (2) and the drive output (3), the transmission device (4) comprises at least two transmission units (7, 8) whose transmission ratios are continuously variable at least in some ranges, and which are arranged in power-trains (9, 10) running parallel with one another between the drive engine (2) and the drive output (3), and the power-trains (9, 10) are each functionally connectable with a respective vehicle axle (5, 6) of the drive output (3), at least one shifting element (16) is provided, by which the power-trains (9, 10) are functionally connectable with one another in an area between the two transmission units (7, 8) and the drivable vehicle axles (5, 6), the method comprising:
actuating the shifting element (16) as a function of torque which is to be transmitted between the drive engine (2) and the drive output (3) by way of the transmission device (4).

20. The method according to claim 19, further comprising changing the shifting element (16) to an engaged operating condition, if a predefined threshold value of the torque to be transmitted by way of the transmission device (4) between the drive engine (2) and the drive output (3) is exceeded.

21. The method according to claim 19, further comprising interrupting the force flow between the drive engine (2) and the drive output (3) in the area of one of the power-trains (9, 10), if the torque currently to be transmitted by way of the transmission device (4) between the drive engine (2) and the drive output (3) is below a threshold value.

22. The method according to claim 19, further comprising controllably regulating slipping in an area of wheels of the drivable vehicle axles (5, 6) by varying the transmission ratio in an area of the transmission units (6, 7) with the shifting element (16) either disengaged or operating with slip.

23. The method according to claim 19, further comprising, in an area of one of the transmission units (7), which is in a form of a continuously variable power branched transmission with a variator designed as a hydrostat, carrying out a transmission ratio and high-pressure regulation by virtue of an adjustment strategy that takes a current driver's wish into account.

24. The method according to claim 23, further comprising, in an area of the further transmission unit (8), which is also in a form of a continuously variable power branched transmission with a variator designed as a hydrostat, carrying out a transmission ratio regulation whereas the high-pressure regulation in the area of the variator of the further transmission unit (8) is operated as a function of the high-pressure regulation in the area of the other transmission unit (7).

25. A vehicle drive-train (1) comprising:
a drive engine (2),
a drive output (3),
a transmission device (4) being connected in a flow of power between the drive engine (2) and the drive output (3),
the transmission device (4) including at least two transmission units (7, 8) having transmission ratios that are continuously variable at least in some ranges, and which are arranged in power-trains (9, 10) running parallel with one another between the drive engine (2) and the drive output (3),
the power-trains (9, 10) being functionally connectable with a respective drivable vehicle axle (5, 6) of the drive output (3), and
at least one shifting element (16) being engagable to functionally connect the two power-trains (9, 10) in an area between the two transmission units (7, 8) and the drivable vehicle axles (5, 6).
